(19) United States
(12) Patent Application Publication
(10) Pub. No.: US 2011/0004611 A1
(43) Pub. Date: Jan. 6, 2011

(54) METHOD AND SYSTEM FOR PROVIDING CONTENT-BASED ACCESS TO PRESENCE METHOD AND SYSTEM FOR PROVIDING CONTENT-BASED TO PRESENCE INFORMATION

(75) Inventors: Omri Fuchs, Haifa (IL); Roni Korenshtein, Haifa (IL); Sima Nadler, Haifa (IL); Vladimir Soroka, Haifa (IL)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 12/495,837

(22) Filed: Jul. 1, 2009

(51) Int. Cl. G06F 17/30

(52) U.S. Cl. 707/769; 707/759

(57) ABSTRACT

A method and system for providing content-based access to presence information for an entity are described. The method, which may be implemented in a server, includes maintaining a plurality of state definitions for entities, each state definition including an expression of conditions to be met in data of presence information for an entity. The method further includes receiving presence information for an entity, evaluating in a computer-based application, the presence information for the entity with respect to the state definitions to determine if a state definition evaluates to true against the presence information, and providing results of a state definition. The results may be provided as a subscription to a state definition or in reply to a query request for a state definition.

### FIELD OF THE INVENTION

This invention relates to the field of providing presence information. In particular, the invention relates to providing content-based access to presence information.

### BACKGROUND OF THE INVENTION

Presence information provides information on whether an entity is available. A presentity is an entity described by presence information. The word is a combination of words “presence” and “entity”. A presentity usually refers to a human, in which case presence information describes availability and willingness of this human to communicate via set of communication services.

For example, users or contacts of an instant messaging service are presentities and their presence information is user status (online, offline, away, etc.). Another example, is for users of voice over IP applications.

A presentity can also refer to a group of humans, for example a collection of customer service agents in a call center. This presentity may be considered available if there is at least one agent ready to accept a call.

A presentity can also refer to non human entities, that have states which may change and are of interest to other entities.

A presence service is a network service which accepts, stores and distributes presence information. A presence service may be implemented as a single server or have an internal structure involving multiple servers and proxies. Also presence service may be implemented as direct communication among presentity and watchers, i.e. server is not required.

Presence information for a presentity may be distributed as a presence document by a presence server. Subscribers subscribing to the presentity can receive notifications whenever the presence information of the presentity changes.

The current availability of presence information does not allow for presence server to determine, at a given point in time, which presentities are in a certain specified published state, for example, which presentities are currently in Jerusalem on vacation.

The current publish/subscribe systems do not allow for an application to receive a notification whenever any presentity's presence changes to a certain state, for example, when the presentity who is on vacation has gone online. A state is represented by the data in the published presence document of the presentity.

The above problems currently require every application interested in any of the above to subscribe to all presentities and when notifications arrive to screen and filter the publications based on their needs.

### SUMMARY OF THE INVENTION

According to a first aspect of the present invention there is provided a method for providing content-based access to presence information for an entity, comprising: maintaining a plurality of state definitions in an electronic database, each state definition including an expression of conditions to be met in data of presence information for an entity; receiving presence information for an entity; evaluating in a computer-based application, the presence information for the entity with respect to the state definitions to determine if a state definition evaluates to true against the presence information; providing results for a state definition; and wherein any of said steps are implemented in either of computer hardware or computer software and embodied in a computer-readable medium.

In one embodiment the method includes: receiving a query request for a state definition; retrieving stored evaluations of presence information for entities with respect to the state definition; and wherein providing results for a state definition includes providing a list of identities of entities for which the state definition evaluates to true against the entities' presence information.

In another embodiment the method includes: receiving a subscribe request to a state definition; and wherein providing results for a state definition includes distributing the identity of an entity for which presence information has been received and for which the state definition of the subscription evaluates to true for the presence information. The step of providing results may include distributing a reference to the subscribed state definition or subscribe request. The step of providing results may include distributing multiple notifications over time in response to a subscribe request, a new notification being distributed when presence information is received and evaluated against a state definition.

The step of receiving a subscribe request to a state definition may subscribe to when the state definition becomes true for an entity. Alternatively, receiving a subscribe request to a state definition may subscribe to changes in a state definition; and providing results may include providing a value of the state definition.

The results of evaluating step may be stored as an entity having a state definition in a computer-readable storage medium. Alternatively, the evaluating step may derive the results in response to a request.

A state definition may be formed of logical operators between sub-expressions, wherein the core of each sub-expression identifies an element or an element's attribute value in a rich presence document. A sub-expression may refer to another state definition.

The method may include restricting access to state definitions with respect to requests by clients.

Evaluating the presence information for the entity may include parsing the presence information and going through the expression in the state definition.

A state definition may be designated as active or inactive at a given time, and a request may be sent to activate one or more state definitions, wherein only active state definitions are evaluated.

A subscription request may specify how the notification is to be sent.

According to a second aspect of the present invention there is provided a computer program product for providing content-based access to presence information for an entity, the computer program product comprising: a computer readable medium; computer program instructions operative to: maintain a plurality of state definitions in an electronic database, each state definition including an expression of conditions to be met in data of presence information for an entity; receive presence information for an entity; evaluate in a computer-based application, the presence information for the entity with respect to the state definitions to determine if a state definition evaluates to true against the presence information; provide results for a state definition; and wherein results in the form of a list of entities meeting the conditions of a state definition are provided on request; and wherein said program instructions are stored on said computer readable medium.

According to a third aspect of the present invention there is provided a method of providing a service to a customer over a network for providing content-based access to presence information for an entity, the service comprising: maintaining a plurality of state definitions in an electronic database, each state definition including an expression of conditions to be met in data of presence information for an entity; receiving presence information for an entity; evaluating in a computer-based application, the presence information for the entity with respect to the state definitions to determine if a state definition evaluates to true against the presence information; providing results for a state definition; and wherein results in the form of a list of entities meeting the conditions of a state definition are provided on request.

According to a fourth aspect of the present invention there is provided a system for providing content-based access to presence information for an entity, comprising: a hardware based server including a processor; the server including: a storage device storing a plurality of state definitions for entities, each state definition including an expression of conditions to be met in data of presence information for an entity; a receiving mechanism for receiving presence information for an entity; a module for evaluating the presence information for the entity with respect to the state definitions to determine if a state definition evaluates to true against the presence information; and a results mechanism for providing results for a state definition; wherein any of said receiving mechanism, module for evaluating, and results mechanism are implemented in either of computer hardware or computer software and embodied in a computer readable medium.

In one embodiment, the system includes a communication interface for receiving a query request for a state definition; and includes a storage medium for storing evaluations of presence information for entities with respect to the state definition; and wherein the results mechanism provides a list of identities of entities for which the state definition evaluates to true against the entities' presence information.

In another embodiment, the system includes a subscription mechanism for receiving a subscribe request to a state definition; and wherein the results distribute the identity of an entity for which presence information has been received and for which the state definition of the subscription evaluates to true for the presence information.

The system may include a computer-readable storage medium for storing the results of the module for evaluating as an entity having a state definition. Alternatively, the results mechanism may derive the results in response to a request.

The system may include a mechanism for restricting access to state definitions with respect to requests by clients.

The system may include a designation mechanism wherein a state definition is designated as active or inactive at a given time, and a request may be sent to activate one or more state definitions, wherein only active state definitions are evaluated.

The described method and system enable a client to perform a content-based query specifying a presence state and receive a list of presentities for which the query matched. A client may alternatively subscribe to a certain presence state and receive notification whenever any presentity publishes a document according to which the presentity is in that state.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a system for providing presentity information as known in the art;

FIG. 2A is a block diagram of a system in accordance with the present invention;

FIG. 2B is a block diagram of one embodiment of the system of FIG. 2A in accordance with an aspect of the present invention;

FIG. 3 is a block diagram of a computer system in which the present invention may be implemented;

FIG. 4 is a flow diagram of a method in accordance with the present invention;

FIG. 5 is a flow diagram of a method in accordance with an embodiment of the present invention;

FIG. 6 is a flow diagram of a method in accordance with an embodiment of the present invention; and

FIG. 7 is a flow diagram of a method in accordance with an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

A method and system are described for enabling content-based access to presence information for presentities. The term presentity is used throughout this document and should be interpreted as any entity described by presence information.

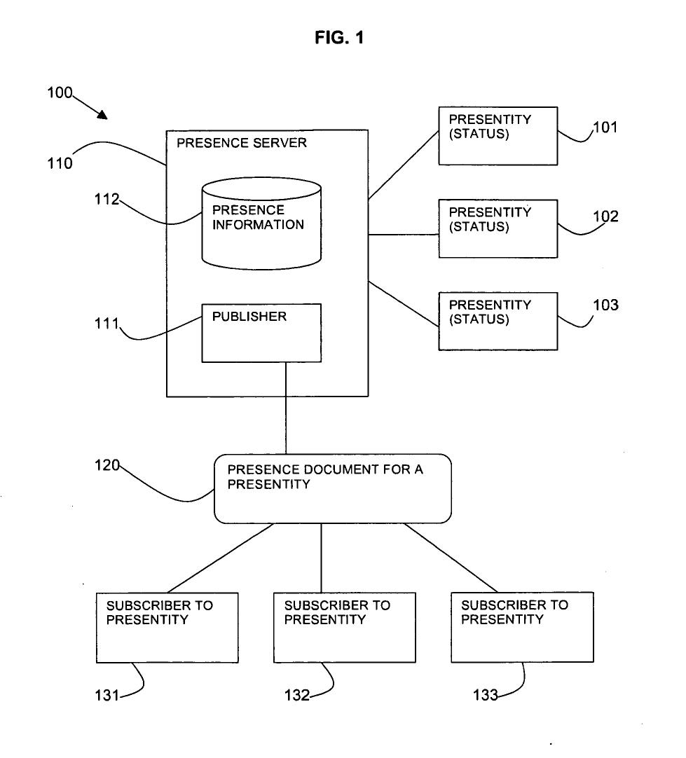

Referring to FIG. 1, a system 100 is shown as known in the prior art in which a plurality of presentities 101-103 have presence information which is provided by a presence server 110.

The presence server 110 accepts, stores and distributes presence information 112 relating to the communication status of presentities 101-103. The presence server 110 may include a publisher application 111 which publishes presence documents 120 for the presentities 101-103. A presence document 120 has presence information coded into a document and may include binary or textual presence information relating to a presentity 101-103. For example, as an XML (Extensible Markup Language) document, as free text, in binary proprietary format, or any other format. Subscribers 131-133 who are interested in a presentity 101-103, subscribe to published presence documents 120 for that presentity 101-103 and receive updates when the presence document changes.

When presence information 112 is distributed by a presence server 110 an expiry of the presence information 112 may be included.

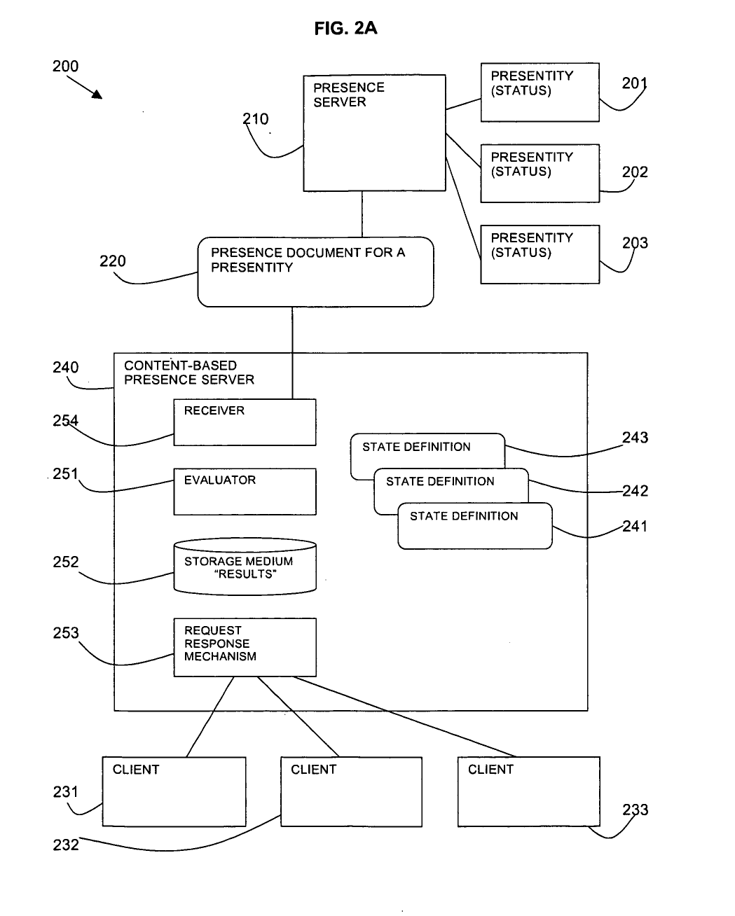

Referring to FIG. 2A, an embodiment of the described system 200 is shown. A plurality of presentities 201-203 have a presence information which is provided by a presence server 210 as known in the art.

The described system provides a content-based presence server (CBPS) 240 for providing content-based access to presence information for presentities 201-203. Clients 231-233 may send content-based query requests or content-based subscribe requests to the CBPS 240.

The CBPS 240 may be integrated into the presence server 220, it may be loosely coupled to the presence server 210, or it may be a subscriber of the presence server 210. The CBPS 240 may be a machine or a cluster of machines. It may be deployed on the same machines as the presence server 210 or different ones. The CBPS 240 may manage subscriptions and notifications in the same manner as the presence server 210 does with respect to the affinity and intra-cluster communication between machines. The CBPS 240 may manage notifications from more than one presence server 210.

The CBPS 240 is fed a set of defined state definitions 241-243. Each state definition (SD) has a name and a logical expression. The name identifies the state and the expression identifies conditions that must be met in the data of the published presence document. Since the presence document is a structured document (for example, an XML document) the expression identifies which nodes in the structure should have which data values.

The CBPS 240 attaches itself to a presence server 210 and receives presence information in the form of presence documents 220 of presentities 201-203 when their status changes. The presence documents 220 distributed by a presence server 210 may include an expiry time of the presence information.

The CBPS 240 includes a receiver 254 for receiving presence documents 220 or fragments of them, and an evaluator 251 for evaluating a presence document 220 with respect to the state definitions 241-243. A storage medium 252 stores the results of the evaluation for each presentity 201-203. The CBPS 240 also includes a request response mechanism 253 for responding to content-based presence information access requests from clients 231-233.

Whenever the CBPS 240 receives a presence document 220 (or a fragment of a presence document) relating to a presentity 201-203, it determines whether the presentity 201-203 is in any of the known states by evaluating the logical expression of a SD 241-243. The CBPS 240 then stores the result of each evaluation with respect to the presentity 201-203 and the SD 241-243. For example, the Boolean result is the value of the SD for that presentity.

The CBPS 240 may not, in practice, evaluate every SD 241-243 for a presence document 220. In practice, the SDs 241-243 may be rationalized to limit the number that need checking.

The CBPS 240 handles expiry of presence information just like the reception of new presence information. When the presence information expires, it may result in SDs 241-243 being evaluated again, and results provided.

The request response mechanism 253 of the CBPS 240 may take different forms. In a first embodiment, a client performs a query by submitting a request specifying the name of the SD in which they are interested. The request response mechanism 253 includes query receiving and processing functionality. The CBPS 240 responds to the query by examining its storage 252 and obtaining all presentities whose specified SD's value is true and returning the matching presentities identities. This request is most likely synchronous but may be asynchronous.

In a second embodiment, clients 231-233 make a content-based subscribe request by passing a request containing the name of the SD for which they want to receive notifications. Referring to FIG. 2B, the CBPS 240 includes a request response mechanism 253 in the form of a subscriber mechanism 260. The subscriber mechanism 260 includes lists 261-263 of subscribers to each active SD 241-243. The lists 261-263 may be divided into separate lists for subscribers requiring notification when the value of the SD changes 261A-263A, and subscribers requiring notification when an SD value becomes true 261B-263B. Subscribers' details 264 are also stored in the subscriber mechanism 260 including how and where to send notifications.

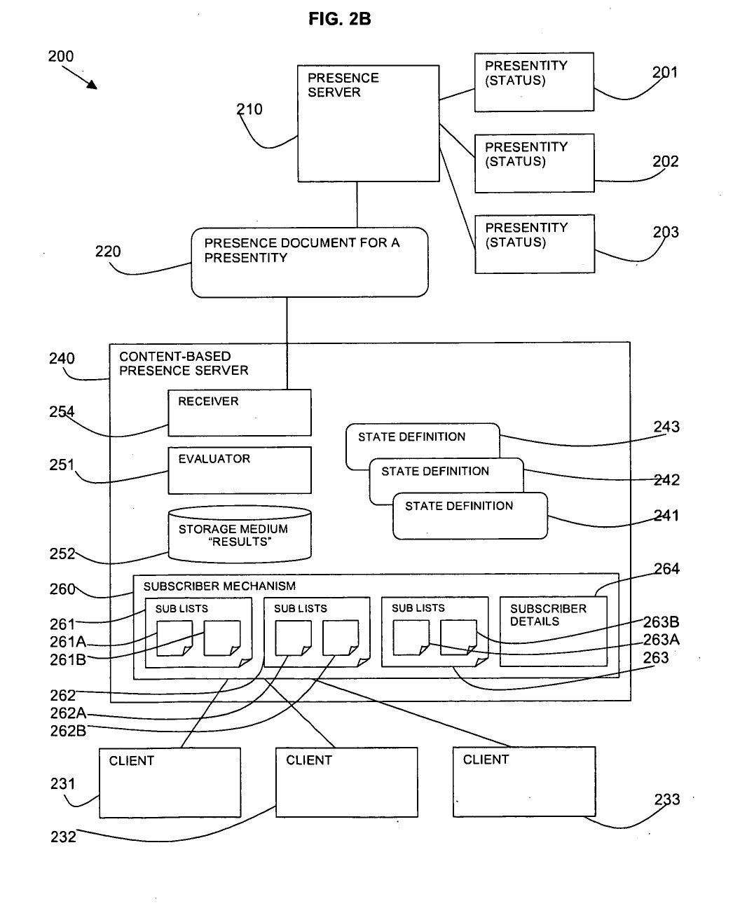

Referring to FIG. 3, an exemplary system for implementing a presence server 220, CBPS 240 and clients 231-233 includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

The CBPS has a defined set of state definitions. Each state definition has a name and an expression. The expression is Boolean and may involve any logical operator between sub-expressions. The core of each sub-expression identifies an element/node of the (XML) rich presence document or an attribute of an element and a value.

For example, x/y/z.u=“yes” is an expression which evaluates to true if there exists a top element x which has a y element in it and that y element has an element called z in it and z has an attribute called u and that attribute's value is “yes”.

XPATH and other standard specifications may be used to define the SD expressions.

SD's sub-expressions may refer to other SD's by name. For example, if an SD named “Available” is defined then an SD named “AvailableInJerusalem” may be defined which refers to the SD “available” in its expression (Available AND<expr checking that presentity is in Jerusalem>).

There may be some functions that may be used in expressions such as Contains, Exists, etc.

### EXAMPLES

| | |
|---|---|
| SD name: | AtHome |
| SD expression | tuple/status/rs:place-type=“home” |
| Remarks | There exists a tuple containing a note “status” containing |
| | a node “rs:place-type” whose value is “home” |
| SD name | AwayFromHome |
| SD expression | NOT AtHome |
| Remarks | A tuple such as specified by the AtHome |
| | expression does not exist. |
| SD name | InMeeting |
| SD expression | Contains (“presence/tuple/status/rs:activities”, |
| | “rs:activity=“meeting”) |
| Remarks | Note the usage of the schema designation (rs:) |
| | and the use of the |
| | Contains function which means in this case that the |
| | activities node may contain several |
| | “es:activity” nodes. |

An expression may specify, for example, that there exists:
a tuple in which several conditions are true; or
there exists a tuple/element in which several conditions are true and there exists a same or different tuple/element in which several other conditions are true and the two tuples are the same or different.

Expressions may also contain wild card characters.

A sample presence document is given below. It evaluations to true for the above expressions. The presence document describes that the user is at home (<rs:place-type until=2008-05-25T11:30:00Z”>home</rs:place-type>) and in a meeting (<rs:activity>meeting</rs:activity>).

```
<presence xmlns=“urn:ietf:params:xml:ns:pidf”
        xmlns:pe=“urn:ietf:params:xml:ns:pidf:person”
        xmlns:de=“urn:ietf:params:xml:ns:pidf:device”
            xmlns:pe=“urn:ietf:params:xml:ns:pidf:rpid-
            person”
            xmlns:de=“urn:ietf:params:xml:ns:pidf:rpid-
            device”
        xmlns:rs=“urn:ietf:params:xml:ns:pidf:status:rpid-
        status”
        xmlns:rt=“urn:ietf:params:xml:ns:pidf:rpid-tuple”
        xmlns:ci=“urn:ietf:params:xml:ns:pidf:cipid”
        xmlns:sc=“urn:ietf:params:xml:ns:pidf:status:servcaps
        ”
            xmlns:sc=“urn:ietf:params:xml:ns:pidf:servcaps”
        xmlns:dc=“urn:ietf:params:xml:ns:pidf:status:devcaps”
        entity=“pres:someone@example.com”>
    <tuple id=“cg231jcr”>
        <status>
            <basic>open</basic>
        </status>
        <rs:place-type until=“2008-05-
        25T11:30:00Z”>home</rs:place-type>
        <contact priority=“1.0”>im:pep@example.com</contact>
    </tuple>
    <tuple id=“r1230d”>
        <status>
            <basic>closed</basic>
            <rs:activities>
                <rs:activity>meeting</rs:activity>
            </rs:activities>
        </status>
        <ci:homepage>http://example.com/~pep/</ci:homepage>
        <ci:icon>http://example.com/~pep/icon.gif</ci:icon>
        <ci:card>http://example.com/~pep/card.vcd</ci:card>
        <contact priority=“0.9”>sip:pep@example.com</contact>
    </tuple>
        <note xml:lang=“en”>Full state presence
        document</note>
    </presence>
```

All SD's may be active all the time; alternatively, a request needs to be sent to activate a certain SD. If a request needs to be sent to activate an SD, then all or some SD's are inactive initially and become activated upon receiving a request to activate a certain SD. SD's may be activated or de-activated, individually or all in a single request.

SDs are fed into the system by a modeller and the SDs are maintained in a database. An SD may be active/inactive for either query or subscribe. Inactive SD's are not processed, in other words, when presence information of a certain presentity is received by the CBPS it only evaluates active SD's expressions against the document.

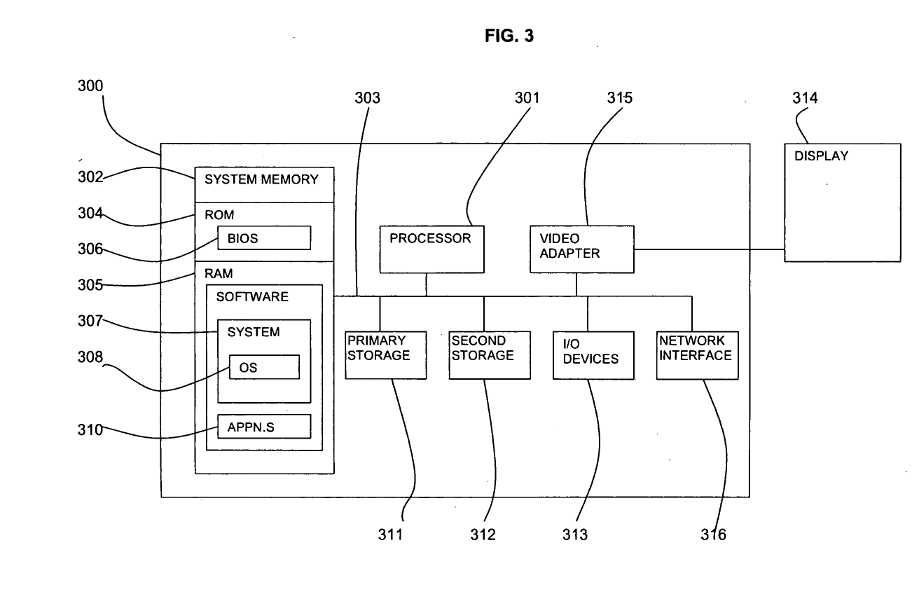

Referring to FIG. 4, a flow diagram 400 shows a method carried out at a CBPS. A presence document or a fragment of a presence document is received 401 at the CBPS for a presentity. The presence document is evaluated 402 with respect to the state definitions in the CBPS. The results are stored or returned 403 for a presentity with a state definition.

The current disclosure derives its augmenting information from the presence information, and while it may store it as an augmenting storage, it does not necessarily need to store it. In fact it may be conceptualized as nonexistent until the point of the query, at which time it is conceptually queried, derived and returned.

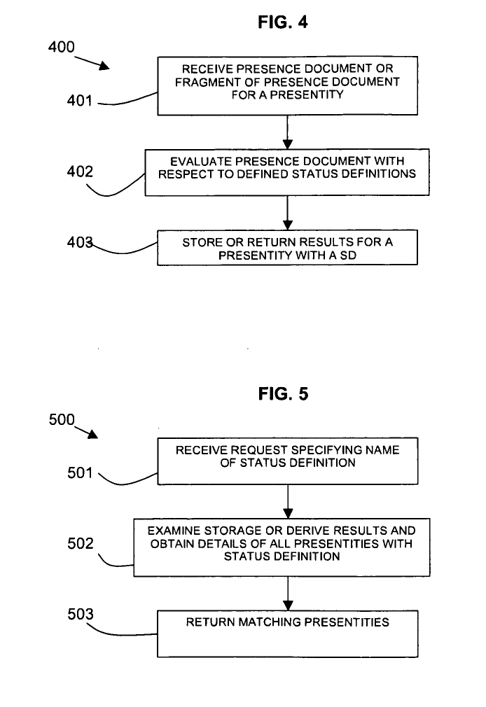

Referring to FIG. 5, a flow diagram 500 shows a method carried out at a CBPS of the first embodiment when receiving a request specifying the name of the SD in which a client is interested. A request is received 501 and the CBPS examines its storage or derives the result 502 to obtain all presentities whose specified SD's value is true and returns 503 the matching presentities identities. When a query request is received, it is immediately responded to and returns a list of identities of presentities.

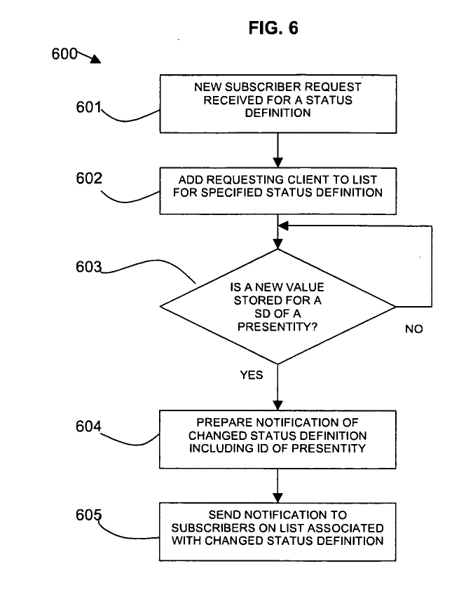

Referring to FIG. 6, a flow diagram 600 shows a method carried out at a CBPS of the second embodiment, processing a subscriber request. A new subscriber request is received 601 and the requesting client is added 602 to a list associated with the specified SD. It is determined 603 when a new value is stored for a certain SD of a certain presentity, (based on presence information that it received from the PS). If no new value is stored, the process loops to await a new value. When a new value is stored, a notification is prepared 604 including the ID of the presentity to which it relates and sent 605 it each of the content-based subscribers in the list associated with the changed SD. The notification sent contains the presentity identity and may contain the SD name, the SD new value, and it may also send all or part of the presence document of the presentity. The notification may include a reference that ties the notification to the subscriber request.

A subscribe request may be received by a CBPS at any time and may result in multiple responses over the lifetime of the subscription when presence information is received. A subscribe request results in sending notifications containing a single identifier of the presentity for which presence information has been received and for which the subscription request requires a response.

When a request is received, the CBPS may check whether the authenticated subscribing client has the credentials to subscribe to/query the SD specified in the request.

When a subscribe request is received, the CBPS may send back an empty acknowledgement response. Alternatively, the CBPS may query which presentities meet the condition specified by the request's SD and respond with the list of presentities. In both cases notifications will follow once new presence information is received by the CBPS. The second option is more in line with the model a presence server implements.

A subscriber may end a subscription by sending an unsubscribe request cancelling a previously submitted subscribe request to some SD.

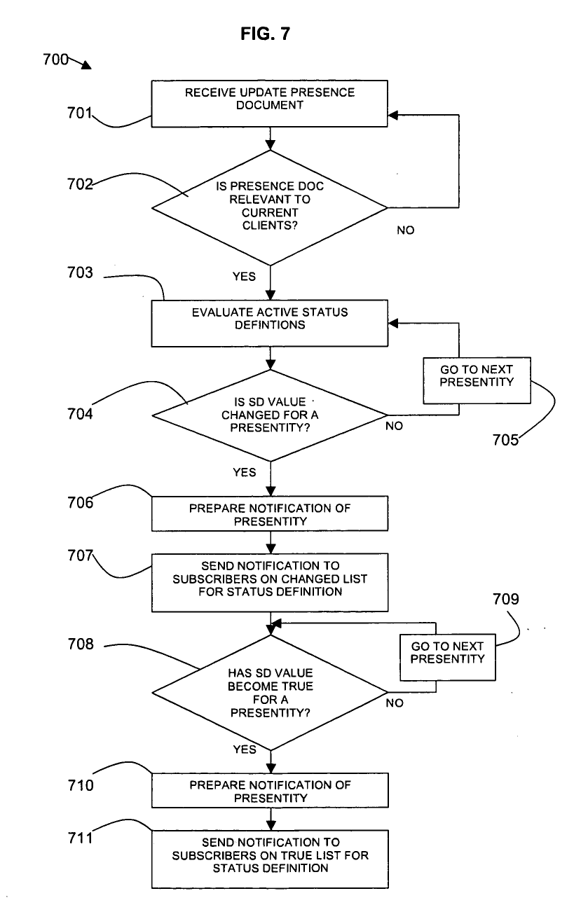

Referring to FIG. 7, a flow diagram 700 shows a process upon receiving 701 a presence document at the CBPS. The CBPS carries out 702 a quick scan to see if the presence document is of interest to current clients. If it is, it evaluates 703 active SD's expressions.

Going through each presentity 705, for each SD whose value with respect to the presentity has changed 704, prepare 706 a notification, and send 707 the notification to every subscriber in the “changed” list.

Going through each presentity 709, for each SD whose value with respect to the presentity has become “true” 708, prepare 710 a notification, and send 711 the notification to every subscriber in the “true” list.

The CBPS may perform a quick scan for the existence of some string obtained from the SD's expression (for example, for ‘z’ based on the example above). Only if the scan succeeds is the document parsed and walked through the nodes specified in the path of the SD's expression.

Requests may be passed to the SD in various formats and using a multitude of technologies. A request may specify how the subscriber wants notifications/responses sent back to it.

The CBPS may require authentication of clients and implement an access control per SD with respect to query or subscribe operations.

The CBPS augments the presence information of a presentity. It derives state information from the presence information and stores it (e.g. storing the fact that a certain presentity is now in a certain state)

The disclosure does not deal with querying or subscribing to certain presentities, but rather to subscribing or querying conditions of presentities, (for example, subscribing to

presentities whose status is “available”). The results of such queries or subscriptions yield all presentities for which attributes of their presence information matches the queried state.

The described method and system deals with how users (most likely non-human) subscribe to a condition or a state rather than to a presentity. So while in most related prior art, the subscriber receives presence information related to the presentity for which it subscribes; the subscriber using the described mechanism receives the identities of a set of presentities whose presence information matches a pattern to which the subscriber subscribed.

For example, a user may specify that she wants to subscribe only to the presentities in her buddy list which are currently “at home”. As presentities in her buddy list get home the user will get notifications when a certain buddy got home as well as when a buddy has left his home.

An example application of the described method is an advertising agency who wishes to send advertising material to entities when they have a particular status, for example, are at home. The advertising agency may not need to know the identities of the entities, but may simply get a list of addresses for any entities with the given state definition.

A content-based presence server may be provided as a service to a customer over a network.

The invention can take the form of an entirely hardware embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for providing content-based access to presence information for an entity, comprising:
maintaining a plurality of state definitions in an electronic database, each state definition including an expression of conditions to be met in data of presence information for an entity;
receiving presence information for an entity;
evaluating in a computer-based application, the presence information for the entity with respect to the state definitions to determine if a state definition evaluates to true against the presence information;
providing results for a state definition; and
wherein any of said steps are implemented in either of computer hardware or computer software and embodied in a computer-readable medium.

2. The method as claimed in claim 1, including:
receiving a query request for a state definition;
retrieving stored evaluations of presence information for entities with respect to the state definition; and
wherein providing results for a state definition includes providing a list of identities of entities for which the state definition evaluates to true against the entities' presence information.

3. The method as claimed in claim 1, including:
receiving a subscribe request to a state definition; and
wherein providing results for a state definition includes distributing the identity of an entity for which presence information has been received and for which the state definition of the subscription evaluates to true for the presence information.

4. The method as claimed in claim 3, wherein providing results includes distributing a reference to the subscribed state definition or subscribe request.

5. The method as claimed in claim 3, wherein receiving a subscribe request to a state definition subscribes to when the state definition becomes true for an entity.

6. The method as claimed in claim 3, wherein receiving a subscribe request to a state definition subscribes to changes in a state definition; and providing results includes providing a value of the state definition.

7. The method as claimed in claim 1, wherein the results of the evaluating step are stored as an entity having a state definition in a computer-readable storage medium.

8. The method as claimed in claim 1, wherein the evaluating step derives the results in response to a request.

9. The method as claimed in claim 1, wherein a state definition is formed of logical operators between sub-expressions, wherein the core of each sub-expression identifies an element or an element's attribute value in a rich presence document.

10. The method as claimed in claim 9, wherein a sub-expression refers to another state definition.

11. The method as claimed in claim 1, including restricting access to state definitions with respect to requests by clients.

12. The method as claimed in claim 1, wherein evaluating the presence information for the entity includes parsing the presence information and going through the expression in the state definition.

13. The method as claimed in claim 1, wherein a state definition is designated as active or inactive at a given time, and a request is sent to activate one or more state definitions, wherein only active state definitions are evaluated.

14. The method as claimed in claim 3, wherein a subscription request specifies how the notification is to be sent.

15. A computer program product for providing content-based access to presence information for an entity, the computer program product comprising:
a computer readable medium;
computer program instructions operative to:
maintain a plurality of state definitions in an electronic database, each state definition including an expression of conditions to be met in data of presence information for an entity;
receive presence information for an entity;
evaluate in a computer-based application, the presence information for the entity with respect to the state definitions to determine if a state definition evaluates to true against the presence information;
provide results for a state definition; and
wherein results in the form of a list of entities meeting the conditions of a state definition are provided on request; and
wherein said program instructions are stored on said computer readable medium.

16. A method of providing a service to a customer over a network for providing content-based access to presence information for an entity, the service comprising:
maintaining a plurality of state definitions in an electronic database, each state definition including an expression of conditions to be met in data of presence information for an entity;
receiving presence information for an entity;
evaluating in a computer-based application, the presence information for the entity with respect to the state definitions to determine if a state definition evaluates to true against the presence information;
providing results for a state definition; and
wherein results in the form of a list of entities meeting the conditions of a state definition are provided on request.

17. A system for providing content-based access to presence information for an entity, comprising:
a hardware based server including a processor;
the server including:
a storage device storing a plurality of state definitions for entities, each state definition including an expression of conditions to be met in data of presence information for an entity;
a receiving mechanism for receiving presence information for an entity;
a module for evaluating the presence information for the entity with respect to the state definitions to determine if a state definition evaluates to true against the presence information; and
a results mechanism for providing results for a state definition;
wherein any of said receiving mechanism, module for evaluating, and results mechanism are implemented in either of computer hardware or computer software and embodied in a computer readable medium.

18. The system as claimed in claim 17, including a communication interface for receiving a query request for a state definition; and including a storage medium for storing evaluations of presence information for entities with respect to the state definition; and wherein the results mechanism provides a list of identities of entities for which the state definition evaluates to true against the entities' presence information.

19. The system as claimed in claim 17, including a subscription mechanism for receiving a subscribe request to a state definition; and wherein the results distribute the identity of an entity for which presence information has been received and for which the state definition of the subscription evaluates to true for the presence information.

20. The system as claimed in claim 17, including a computer-readable storage medium for storing the results of the module for evaluating as an entity having a state definition.

21. The system as claimed in claim 17, wherein the results mechanism derives the results in response to a request.

22. The system as claimed in claim 17, wherein a state definition is formed of logical operators between sub-expressions, wherein the core of each sub-expression identifies an element or an element's attribute value in a rich presence document.

23. The system as claimed in claim 17, including a mechanism for restricting access to state definitions with respect to requests by clients.

24. The system as claimed in claim 17, wherein the module for evaluating the presence information for the entity with respect to a state definition to determine if the entity meets the state definition includes parsing the presence information and going through the expression in the state definition.

25. The system as claimed in claim 17, including a designation mechanism wherein a state definition is designated as active or inactive at a given time, and a request is sent to activate one or more state definitions, wherein only active state definitions are evaluated.
